(19) United States
(12) Patent Application Publication
(10) Pub. No.: US 2012/0191317 A1
(43) Pub. Date: Jul. 26, 2012

(54) Method and Device for Controlling the Operation of an Internal Combustion Engine

(76) Inventors: Armin Mueller-Lerwe, Kerpen-Bergerhausen (DE); Urs Christen, Aachen (DE); Rainer Busch, Aachen (DE); Thomas Rambow, Aachen (DE); Uwe Gussen, Huertgenwald (DE); Markus Kees, Grevenbroich (DE)

(21) Appl. No.: 13/011,963

(22) Filed: Jan. 24, 2011

(51) Int. Cl. B60T 8/32; F02D 28/00

(52) U.S. Cl. 701/93

(57) ABSTRACT

The invention relates to a device and a method for controlling the operation of an internal combustion engine in a motor vehicle, with a brake line, at least one sensor for measuring the brake line pressure in the brake line, a stop-start device for automatically switching off and starting the internal combustion engine, and an adaptive cruise control device for regulating the vehicle speed as a function of environmental information captured in a sensor-based manner, wherein a brake cylinder acting on the brake line is associated with the adaptive cruise control device and wherein the stop-start device and the adaptive cruise control device are coupled to one another in that the automatic switching-off and starting of the internal combustion engine via the stop-start device is executed directly as a function of the brake line pressure measured by the sensor.

### BACKGROUND OF INVENTION

The present invention relates to a method and a device for controlling the operation of an internal combustion engine in a motor vehicle, the motor vehicle being equipped with a stop-start device and with an adaptive cruise control system.

One of the most important challenges in motor vehicle development is the continuous improvement of fuel economy. As a measure suited to this purpose, motor vehicles are equipped with a stop-start device which switches off the internal combustion engine when the vehicle is at standstill and no torque for driving the vehicle or generating electrical energy is required from the internal combustion engine. The internal combustion engine is automatically restarted if torque is needed, for example if the driver would like to set the vehicle in motion, which is typically ascertained by monitoring the actuation of the pedals by the driver (for example, by observing the release process of the brake pedal).

A further modern driver assistance system which is used with the aim of enhancing comfort and reducing stress on the driver is the ACC (Adaptive Cruise Control) system, which is also referred to as automatic following-distance control. The ACC system includes in the speed control function the distance from a preceding vehicle as a feedback and correcting variable, for which purpose the environment of the vehicle is monitored with suitable sensors, cameras, etc.

In extended ACC systems with Stop & Go function, the detected speed range to the lower speed range is extended down to standstill, so that, on the basis of the environmental information captured in a sensor-based manner, the vehicle can be automatically stopped and set in motion again without the pedals having been actuated or released by the driver.

Known from DE 10 2005 062 450 A1 and U.S. Pat. No. 7,345,379 B2 is, inter alia, a control device for automatically stopping and restarting an internal combustion engine, in which an engine stop control module executes an automatic engine control function in order to automatically stop the internal combustion engine when a judgment module for the engine stop conditions determines that all the preset engine stop conditions—except depression of the brake pedal by the driver—are fulfilled.

A vehicle control device is also known from WO 2008/059347 A2, in which a vehicle environment monitoring device detects the possibility of a collision of the vehicle with another vehicle. If such a collision possibility is detected in the stopped mode of the internal combustion engine, and if starting of the internal combustion engine is advantageous, or offers the possibility of preventing the collision, the internal combustion engine is immediately started in order to give the driver the possibility of avoiding a collision.

Known from DE 10 2005 039 193 A1 is a drive control/regulation device for a vehicle which includes a stop hold device which can hold the vehicle in a stopped state by controlling or regulating a brake pressure. In this case the holding of the vehicle in the stopped state can be terminated, in particular if a driver actuation detection device detects that a requested brake pressure, which is connected to a brake actuation carried out by the driver, is equal to or greater than a predetermined appropriate brake pressure, while the vehicle is being held in the stopped state by the stop hold device.

An adaptive speed control system of a vehicle is known from EP 1 072 458 B1, in which a brake control system for controlling the hydraulic brake pressure of the individual wheel brake cylinders is designed to generate a brake pressure on the basis of the magnitude of a brake pedal actuation, and also to generate a brake pressure on the basis of a command signal, output by an adaptive vehicle speed control system (ACC controller), which indicates a desired brake pressure.

In motor vehicles which are equipped both with a stop-start device and with an extended ACC system with Stop & Go functionality, the problem can arise in practice that, with simultaneous activity of both the stop-start device and the ACC system—for example, in the case of standstill of the motor vehicle brought about by the ACC system—the internal combustion engine is switched off via the stop-start device and restarting is permitted only when the driver triggers the restart, for example by pedal actuation.

### SUMMARY OF INVENTION

It is an object of an embodiment of the present invention to provide a device and a method for controlling the operation of an internal combustion engine in a motor vehicle by which malfunctions and undesired behavior of the motor vehicle triggered as a result of a conflict between the stop-start device and the ACC system are avoided.

A device according to an embodiment for controlling the operation of an internal combustion engine in a motor vehicle comprises a brake line, at least one sensor for measuring the brake line pressure in the brake line, a stop-start device for automatically switching off and starting the internal combustion engine, and an adaptive cruise control device for regulating the vehicle speed as a function of environmental information captured in a sensor-based manner, a brake cylinder which acts on the brake line being associated with the adaptive cruise control device.

The device is distinguished by the fact that the stop-start device and the adaptive cruise control device are coupled to one another in that automatic switching-off and starting of the internal combustion engine is executed via the stop-start device directly as a function of the brake line pressure measured by the sensor.

The device is based, in particular, on the concept of bringing about a coupling between the stop-start device and the ACC system via the brake line pressure, in a motor vehicle equipped with both a stop-start device and an adaptive cruise control device (which is also referred to hereinafter as an ACC system and is provided with Stop & Go functionality).

Because a direct linking of the stop-start device to the ACC system is effected via the brake line pressure, instead, for example, of making use of the pedal position or pedal actuation by the driver in the conventional manner, mutually contradictory measures and activations by the stop-start device on the one hand and the ACC system on the other can be avoided.

In particular, independently of whether the ACC system is active, correct and contradiction-free operation of the stop-start device is ensured in that the brake line pressure (as a value influenced in some cases by the ACC system) is evaluated as the decisive value.

Account is thereby taken of situations in which, for example, a change of the brake line pressure is triggered by the ACC system; that is to say that the change of the brake line pressure is not linked to a pedal actuation by the driver of any kind. In such a situation a stop-start device which responded only to pedal actuation would not operate in the desired fashion since, of course, no pedal actuation takes place. With the configuration according to the invention, by contrast, correct and contradiction-free operation continues to be ensured, since the brake line pressure, taken as decisive for the operation of the stop-start device, is correlated with the activity of the ACC system or is influenced by the ACC system.

In other words, both in the case of stopping of the motor vehicle initiated by the ACC system and in the case of restarting of the motor vehicle requested by the ACC system, conflict-free behavior of the stop-start device is ensured in each case, since the stop-start device makes use of the brake line pressure correlating with the operation of the ACC system as the decisive value.

A further advantage of the system is that it can also be implemented in a motor vehicle without an ACC system, and therefore also in motor vehicles with ACC systems which have failed, without fundamental modification of its connection to the system. This is because, as a result of the use of the brake line pressure as the decisive value for the activity of the stop-start device, the stop-start device responding to the brake line pressure operates correctly even if the ACC system has failed or is not present, since any influences of the driver by way of actuating or releasing the brake pedal continue to be interpreted correctly (because of the change in the brake line pressure accompanying the pedal actuation).

According to an embodiment, the stop-start device is configured so as to execute automatic switching-off and starting of the internal combustion engine independently of a pedal actuation by the driver.

According to an embodiment, mutually independent brake cylinders are associated with the brake pedal and with the adaptive cruise control device.

According to an embodiment, the stop-start device automatically switches off the internal combustion engine if the brake line pressure measured by the sensor exceeds a predetermined threshold value. Furthermore, automatic starting of the internal combustion engine by the stop-start device can be executed on the condition that the brake line pressure measured by the sensor is below a predetermined threshold value.

An embodiment further relates to a method for controlling the operation of an internal combustion engine in a motor vehicle, the motor vehicle having a brake line, at least one sensor for measuring the brake line pressure in the brake line, a stop-start device for automatically switching off and starting the internal combustion engine and an adaptive cruise control device for regulating the vehicle speed as a function of environmental information captured in a sensor-based manner, the adaptive cruise control device having a brake cylinder which acts on the brake line, and the automatic switching-off and starting of the internal combustion engine by the stop-start device being executed directly as a function of the brake line pressure measured by the sensor.

According to a further approach, even after the motor vehicle has been stopped through the action of the ACC system, the driver can confirm by an action of the driver independent of a pedal actuation—for example, by actuating a specific button and optionally after a request previously issued to the driver—that the internal combustion engine may be automatically restarted via the stop-start device. Malfunctions and undesired behavior of the motor vehicle triggered by a conflict between the stop-start device and the ACC system can also be avoided thereby, even independently of the above-described coupling of stop-start device to ACC system via the brake line.

According to a further aspect, the invention therefore also relates to a device for controlling the operation of an internal combustion engine in a motor vehicle, which motor vehicle has: a stop-start device for automatically switching off and starting the internal combustion engine, and an adaptive cruise control device for regulating the vehicle speed as a function of environmental information captured in a sensor-based manner, the stop-start device being configured so as to execute the automatic switching-off and starting of the internal combustion engine by an action independent of a pedal actuation, for example by actuation of a specific button.

Further configurations of the invention are apparent from the description and from the dependent claims.

### BRIEF DESCRIPTION OF DRAWINGS

The invention is explained in more detail below with reference to a preferred embodiment and to the appended illustrations, in which:

FIG. 1 is a schematic representation illustrating the structure of an arrangement for controlling the operation of an internal combustion engine in a motor vehicle equipped with a stop-start device and with an adaptive cruise control system;

FIG. 2 is a flow diagram illustrating a method according to an embodiment; and

FIG. 3 is a flow diagram illustrating a method for controlling the operation of an internal combustion engine.

### DETAILED DESCRIPTION

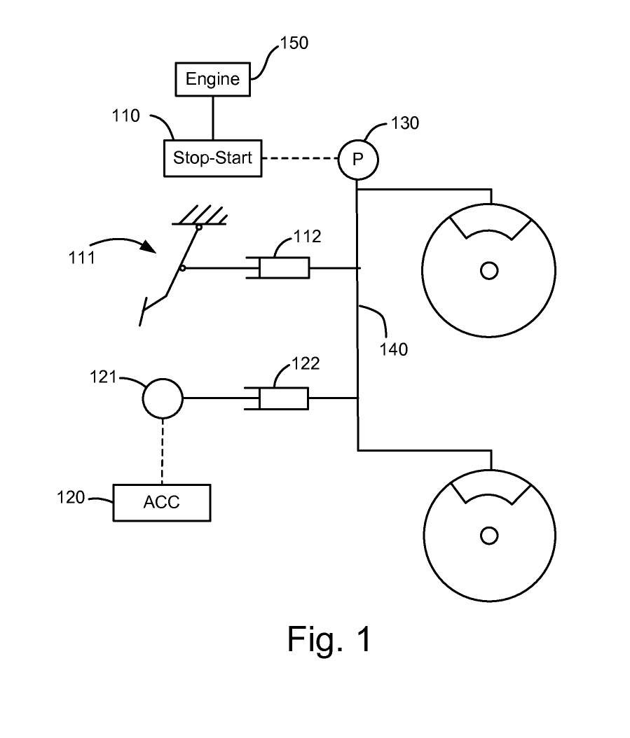

FIG. 1 is a schematic representation illustrating the structure of an arrangement for controlling the operation of an internal combustion engine in a motor vehicle equipped with a stop-start device and with an adaptive cruise control system.

As shown in FIG. 1, the motor vehicle has an engine stop-start device 110, an adaptive cruise control (ACC) system 120 and a brake line 140 in the form of a hydraulic brake circuit. A sensor 130 in the brake line 140 serves to detect the brake line pressure. The brake line pressure measured by the sensor 130 is used as a significant value for the operation of the stop-start device 110.

Furthermore, this brake line pressure is influenced both by actuation of a brake pedal 111, specifically via a first brake cylinder 112 associated with the brake pedal 111, and by the ACC system 120, specifically via a second brake cylinder 122 operated with a motor 121. The second brake cylinder 122 associated with the ACC system 120 therefore acts on the same brake line 140 as the brake pedal 111 and the first brake cylinder 112 associated therewith.

A mode of operation of the stop-start device 110 which responds to the brake line pressure may be implemented, for example, in such a manner that an actuation of the brake is taken as the starting point, and automatic switching-off of the internal combustion engine 150 by the stop-start device 110 is made possible if the brake line pressure exceeds a predetermined threshold value. By contrast, a released state of the brake can be taken as the starting point, and automatic starting of the internal combustion engine via the stop-start device 110 can be made possible if the brake line pressure is below the predetermined threshold value. As is clear from FIG. 1, the conditions relevant to stopping and starting the internal combustion engine can be determined using a single sensor 130, independently of whether the ACC system 120 is active or inactive (for example, has failed or is not present).

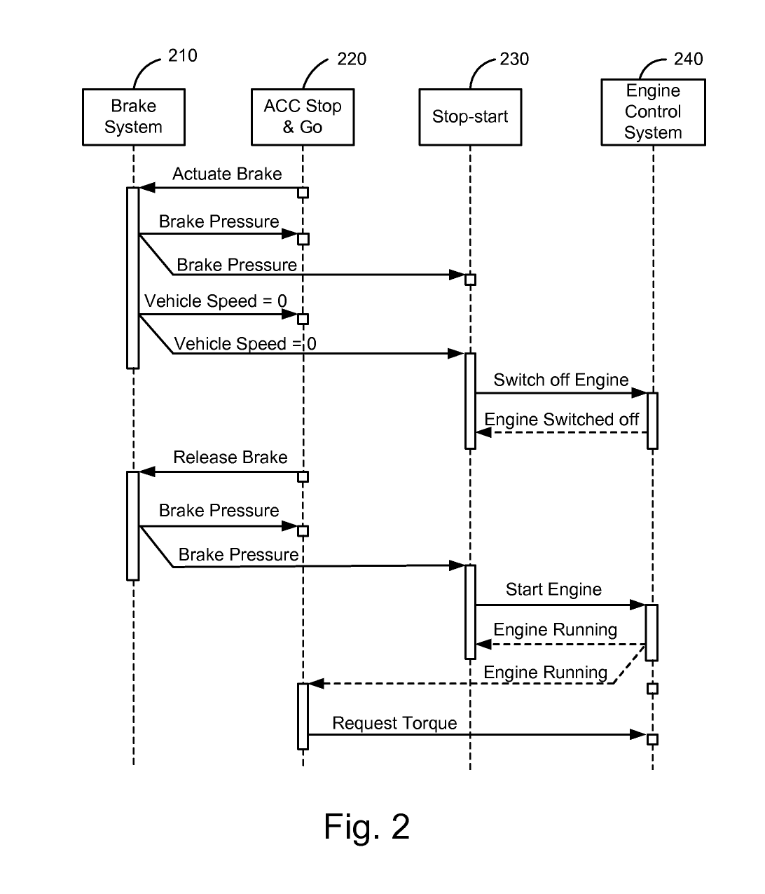

The control system based on the brake line pressure is illustrated in the flow diagram shown in FIG. 2, which will be discussed as it relates to the system of FIG. 1. The brake system 210, ACC stop and go 220, stop-start 230 and engine control system 240 are interlinked. Whether the ACC stop and go 220 actuates the brakes (via the second brake cylinder 122) or the brake pedal 111 is actuated by the driver, an increase in the brake pressure is sensed by sensor 130. If the brake pressure is above a threshold and the vehicle speed equals zero, then the stop-start system 230 signals the engine control system 240 that the engine may be switched off. The engine control system 240 may signal when the engine has been switched off. Then, when the brake pressure drops below another threshold, due to a released brake pedal and/or the ACC releasing the brakes, a signal may be sent to the engine control system 240 to start the engine 150. An engine running signal may be sent back to the ACC and stop-start systems. A torque request from the ACC stop and go system 220 may then be sent to the engine control system 240 to set the vehicle in motion.

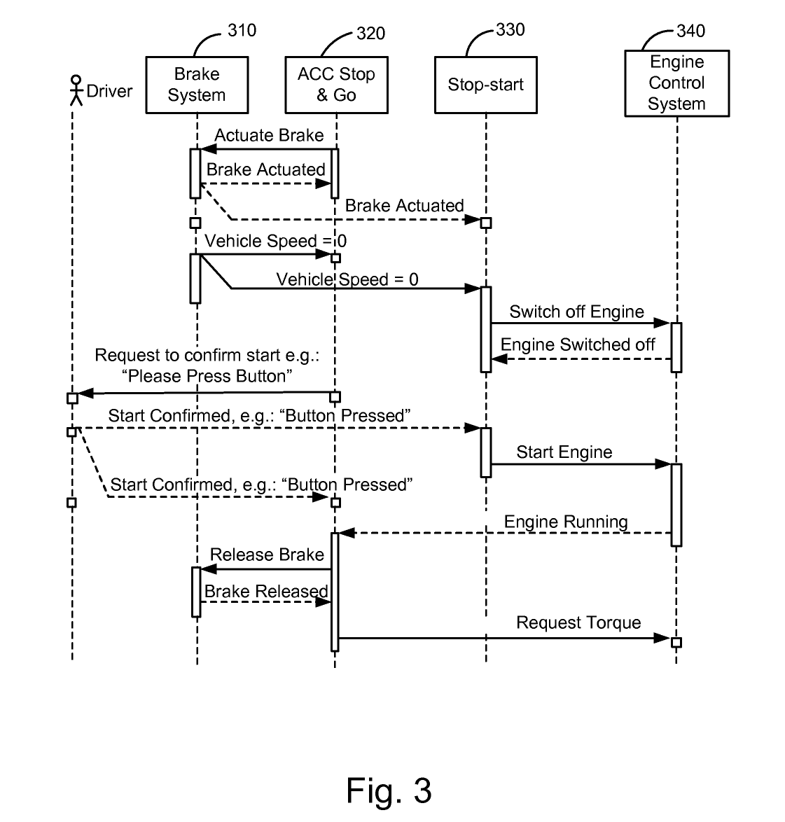

The brake system 310, ACC stop and go 320, stop-start 330 and engine control system 340 are still interlinked for the method illustrated in FIG. 3. In addition though, after stopping of the motor vehicle caused by the ACC stop and go system 320, the driver may confirm by an action independent of a pedal actuation—for example by actuating a specific button to request that the driver confirm start and optionally after a request issued previously to the driver—that the internal combustion engine may be automatically restarted via the stop-start device 330. This gives the driver an added ability to decide if the automatic start and movement of the vehicle is still desired.

With the systems and methods described herein, malfunctions and undesired behavior of the motor vehicle triggered by a conflict between stop-start device and ACC system can be avoided.

While certain embodiments of the present invention have been described in detail, those familiar with the art to which this invention relates will recognize various alternative designs and embodiments for practicing the invention as defined by the following claims.

What is claimed is:

1. A device for controlling the operation of an internal combustion engine in a motor vehicle, comprising:
a brake line;
a sensor for measuring a brake line pressure in the brake line;
a stop-start device for automatically switching off and starting the internal combustion engine; and
an adaptive cruise control device for regulating a vehicle speed as a function of environmental information captured in a sensor-based manner, a brake cylinder that acts on the brake line being actuatable by the adaptive cruise control device;
wherein the stop-start device and the adaptive cruise control device are coupled to one another in that the automatic switching-off and starting of the internal combustion engine is executed via the stop-start device directly as a function of the brake line pressure measured by the sensor.

2. The device as claimed in claim 1 wherein the stop-start device is configured so as to execute the automatic switching-off and starting of the internal combustion engine independently of a pedal actuation by a driver.

3. The device as claimed in claim 2 wherein a second brake cylinder is actuatable by a brake pedal.

4. The device as claimed in claim 1 wherein a second brake cylinder is actuatable by a brake pedal.

5. The device as claimed in claim 1 wherein the stop-start device is configured so as to execute an automatic switching-off of the internal combustion engine only if the brake line pressure measured by the sensor exceeds a predetermined threshold value.

6. The device as claimed in claim 5 wherein the stop-start device is configured so as to perform an automatic start of the internal combustion engine if the brake line pressure measured by the sensor is below a second predetermined threshold value.

7. The device as claimed in claim 1 wherein the stop-start device is configured so as to perform an automatic start of the internal combustion engine if the brake line pressure measured by the sensor is below a predetermined threshold value.

8. A method for controlling the operation of an internal combustion engine in a motor vehicle, the motor vehicle having a brake line, a sensor for measuring a brake line pressure in the brake line, a stop-start device for automatically switching off and starting the internal combustion engine and an adaptive cruise control device for regulating a vehicle speed as a function of environmental information captured in a sensor-based manner, and a brake cylinder which acts on the brake line being associated with the adaptive cruise control device, comprising the steps of:
sensing if the brake line pressure is above a first predetermined threshold;
detecting if the vehicle speed is zero; and
when the brake line pressure is above the first predetermined threshold and the vehicle speed is zero, signaling the engine control system to switch off the engine.

9. The method of claim 8 wherein the start-stop device signals the engine control system to switch off the engine whether the increase in brake line pressure is due to an increase from an actuation of a brake pedal or from the brake cylinder controlled by the adaptive cruise control device.
